(19) United States
(12) Patent Application Publication
(10) Pub. No.: US 2007/0035546 A1
(43) Pub. Date: Feb. 15, 2007

(54) Animation composing vending machine

(76) Inventor: Hyun Ok Kim, Jersey City, NJ (US)

Correspondence Address: JONES DAY, 222 EAST 41ST ST, NEW YORK, NY, 10017, US

(21) Appl. No.: 11/446,373

(22) Filed: Jun. 1, 2006

Related U.S. Application Data
(63) Continuation-in-part of application No. 11/202,781, filed on Aug. 11, 2005.

(30) Foreign Application Priority Data
May 2, 2006 (KR) 10-2006-0039664

(51) Int. Cl. G06T 15/70

(52) U.S. Cl. 345/473

(57) ABSTRACT

An animation composing vending machine automatically composes a specific body part photographed from a user with animation contents. This machine includes a casing, a monitor, a camera for capturing a face image of a user, a CD recorder for recording an animation of the face image captured by the camera in a CD, a manipulation panel, a controller for making the user face image captured by the camera into a composed animation according to a predetermined process and then storing the composed animation in a CD, and databases for storing various data. The controller processes a user face image captured by a camera into a face animation according to a predetermined program, automatically composes the processed face animation with a face-removed animation, and then stores and records the composed animation a CD.

### CROSS-REFERENCE TO RELATED APPLICATIONS

This application is a continuation-in-part application of, and claims priority to, U.S. nonprovisional application Ser. No. 11/202,781, filed on Aug. 11, 2005, the entire contents of which is incorporated herein by reference.

### BACKGROUND OF THE INVENTION

1. Field of the Invention

The present invention relates to an animation composing vending machine, and more particularly to an animation composing vending machine for automatically composing an image of a specific body part photographed from a user with animation contents.

2. Description of the Related Art

Generally, in order to compose an image obtained by photographing a specific body part by a common camera with animation, expensive 3-dimensional (hereinafter, referred to as “3D”) rendering software such as 3D Studio Max, Maya and so on and a high-performance computer capable of operating the 3D rendering software were required in each system and also an operator who may directly manipulate the 3D rendering software was needed.

The expensive 3D rendering software is developed for common use. However, the work for composing a specific body part of a human with animation requires a very small part of functions of the software, which causes unit increase of costs for the system. In addition, since the composing work is not automatically processed, an operator should handle the software, increasing a labor cost.

### SUMMARY OF THE INVENTION

The present invention is designed to solve the problems of the prior art, and therefore it is an object of the present invention to provide an animation composing vending machine capable of automatically composing a specific body part photographed from a user with animation contents and then providing the composed animation as recorded in a compact disk (CD).

In order to accomplish the above object, the present invention provides an animation composing vending machine, which includes a casing: a monitor mounted to the casing a camera mounted to the casing at a position adjacent to the monitor to photograph a user, a CD (Compact Disk) recorder mounted to the casing to record a composed animation of a user face image photographed by the camera in a CD and then provide the CD to the user, a manipulation panel mounted to the casing so that the user inputs a desired command; a controller mounted in connection with the monitor, the camera, the CD recorder and the manipulation panel to process the user face image photographed by the camera into a composed animation and transmit the composed animation to the CD recorder so that the composed animation is recorded in the CD; and a database (DB) unit connected to the controller to store the user face image photographed by the camera, face animation data classified depending on themes, demo animations output to the monitor, and sample animations classified according to themes.

Preferably, the controller instructs the monitor to output the already stored demo animation and a message for guiding payment, instructs the monitor to output a plurality of already stored sample animations so that the user selects a desired sample animation and the number of persons to be photographed, instructs the camera to capture a user face image when a specific sample animation and the number of persons to be photographed are selected through the manipulation panel, renders the captured user face image conforming to a corresponding face animation data of the selected sample animation according to predetermined program to generate a face animation, composes the generated face animation with a face-removed animation of the corresponding sample animation and transmits the composed animation to the CD recorder so that the composed animation is stored in the CD.

Preferably, the face animation data and the face-removed animation are data respectively obtained by data processing of 3D animation.

In addition, a cellular phone transmission module is preferably mounted to the case so as to transmit the composed animation made by the controller to a cellular phone.

Preferably, a cash insert hole is formed in the casing, and the animation composing vending machine further comprises a cash recognition unit for recognizing insertion of cash through the cash insert hole.

In addition, the animation composing vending machine according to the present invention may further include at least one lighting mounted to the case to irradiate light to the user when the user is photographed by the camera.

The animation composing vending machine according to the present invention may further include a cover sheet supplier mounted in the case to supply a cover sheet to be attached to the CD in which the composed animation is recorded; and a printer for printing a predetermined data on the cover sheet supplied by the cover sheet supplier.

Preferably, the animation composing vending machine according to the present invention further includes a blue screen chair, which includes a chair positioned in front of the casing to give a seating place to the user, and a blue screen coupled to the chair and provided in a photographing direction of the camera.

Preferably, the camera photographs the user with the blue screen as a background, and the controller removes a blue screen region from the captured user image using a chroma-key technique, and removes a region below the neck from the photographed image by means of a previously prepared face mask so as to generate the user face image.

In addition, the animation composing vending machine according to the present invention may further include a CD supplier mounted in the case to contain at least one empty CD, the CD supplier supplying an empty CD to the user according to a request of the user.

In addition, the animation composing vending machine according to the present invention may further include a CD supplier mounted in the case to contain at least one empty CD, the CD supplier automatically supplying an empty CD to the CD recorder according to a request of the user.

Preferably, the animation composing vending machine according to the present invention further includes a CD inspection unit for checking normality of the CD in which the composed animation is recorded by the CD recorder at only a CD with no defect is provided to the user.

At this time, the CD in which the composed animation is recorded by the CD recorder may be provided to the user together with a CD case.

The animation composing vending machine according to the present invention may further include an additional monitor mounted to an upper rear side of the to display the same image as the monitor.

Preferably, the animation composing vending machine according to the present invention further includes at least one speaker mounted to an outside of the case to output a sound corresponding to an animation displayed on the monitor.

### BRIEF DESCRIPTION OF THE DRAWINGS

Other objects and aspects of the present invention will become apparent from the following description of embodiments with reference to the accompanying drawing in which:

FIG. 1 is a perspective view showing an animation composing vending machine according to the present invention;

FIG. 2 is a perspective view showing a rear side of the animation composing vending machine according to the present invention;

FIG. 3 is a schematic view showing inner configuration of the animation composing vending machine according to the present invention;

FIG. 4 is a block diagram showing the animation composing vending machine according to the present invention;

FIG. 5 is a block diagram showing a modification of the animation composing vending machine according to the present invention;

FIG. 6 is a flowchart illustrating an operation method of the animation composing vending machine according to the present invention;

FIG. 7 is a block diagram showing the step of process face-removed animation and face animation data previously stored in a database in the animation composing vending machine according to the present invention; and

FIGS. 8 and 9 are schematic diagrams illustrating the step of composing a specific body image photographed from a user with animation contents in the animation composing vending machine according to the present invention.

### DESCRIPTION OF THE PREFERRED EMBODIMENTS

Hereinafter, the present invention will be described in more detail referring to the drawings.

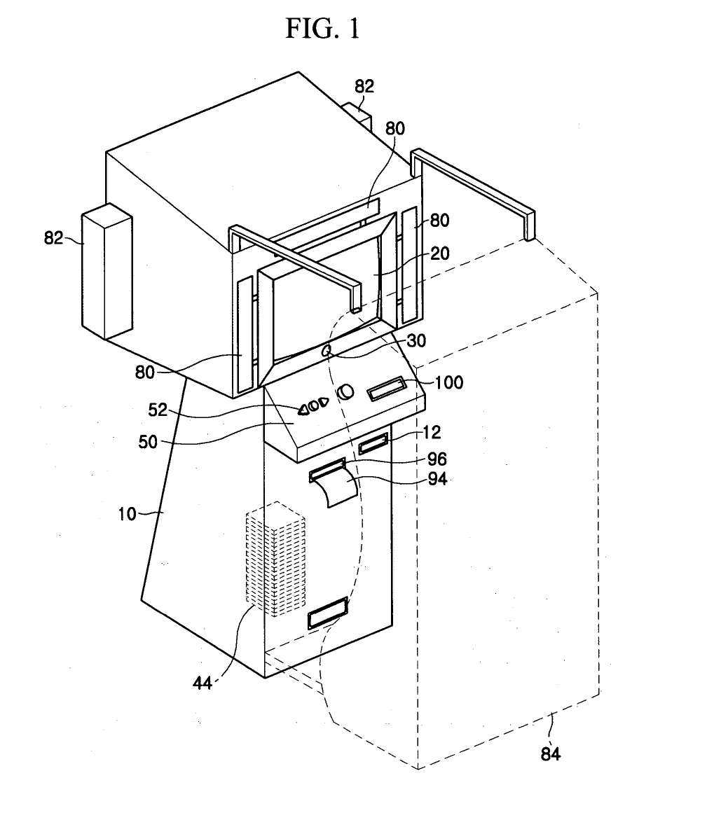

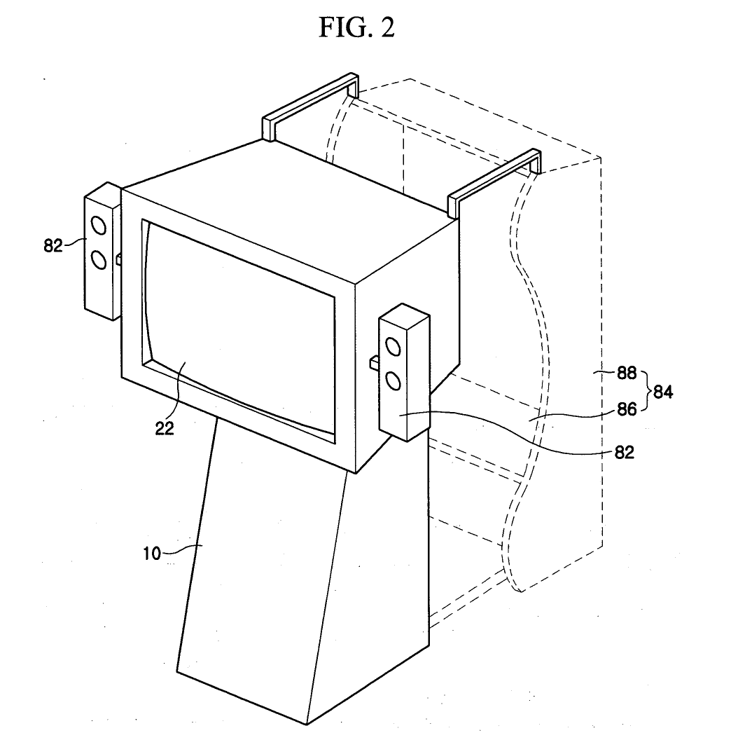

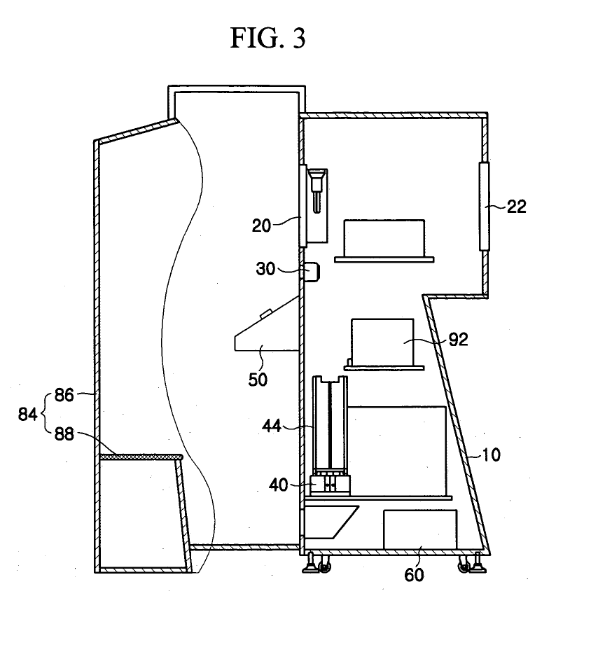

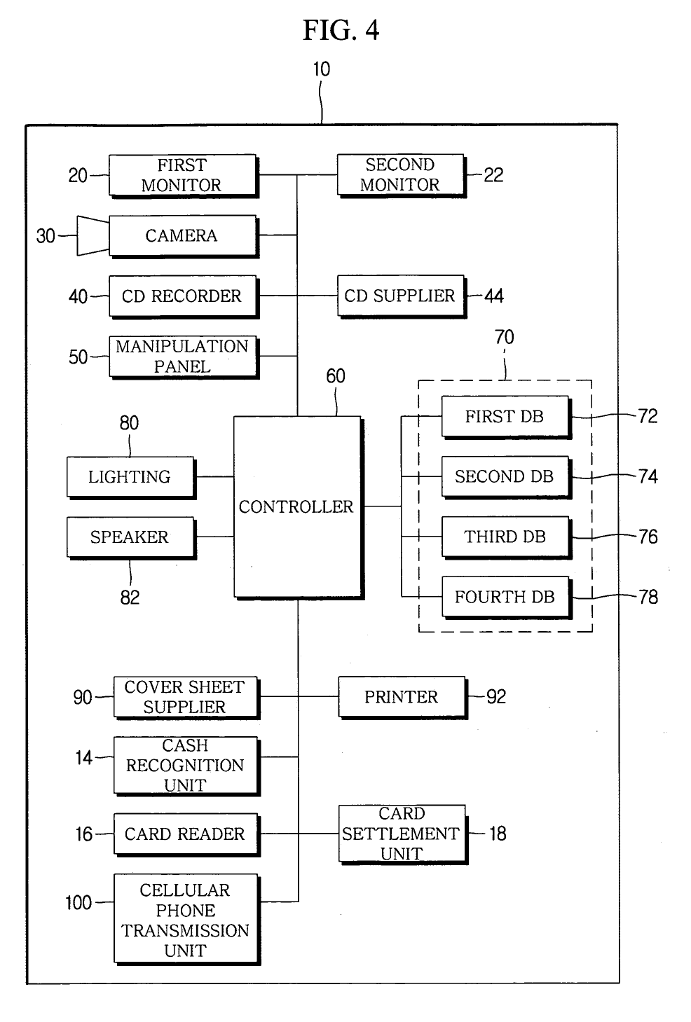

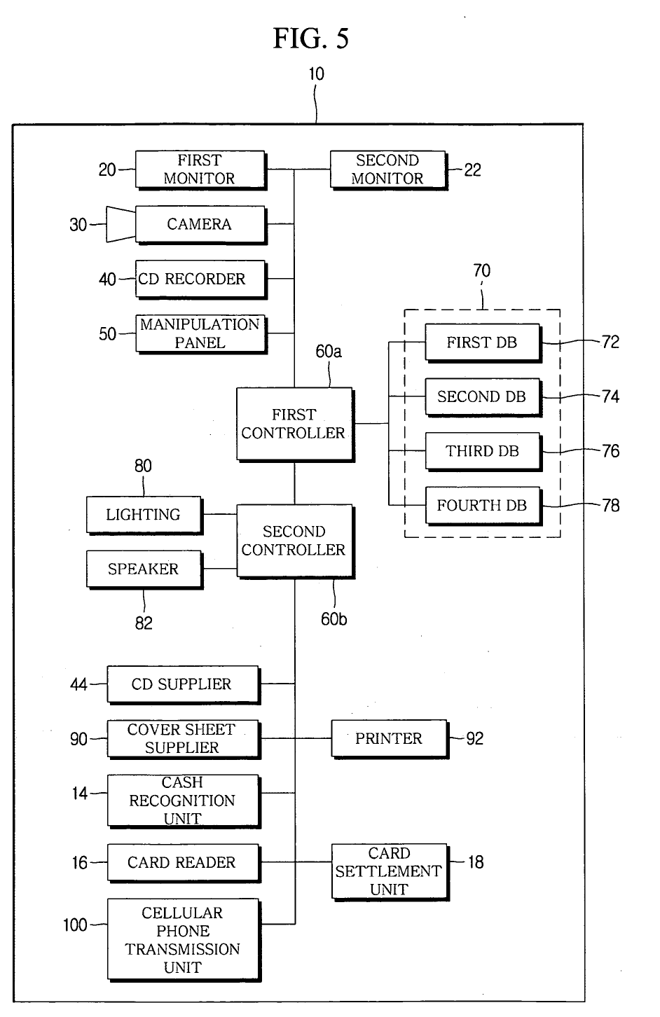

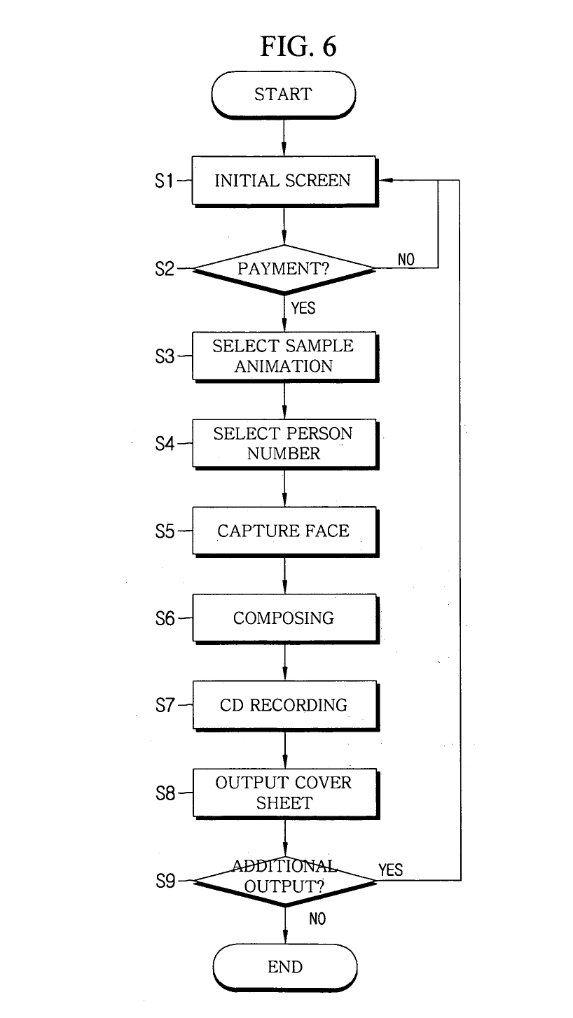

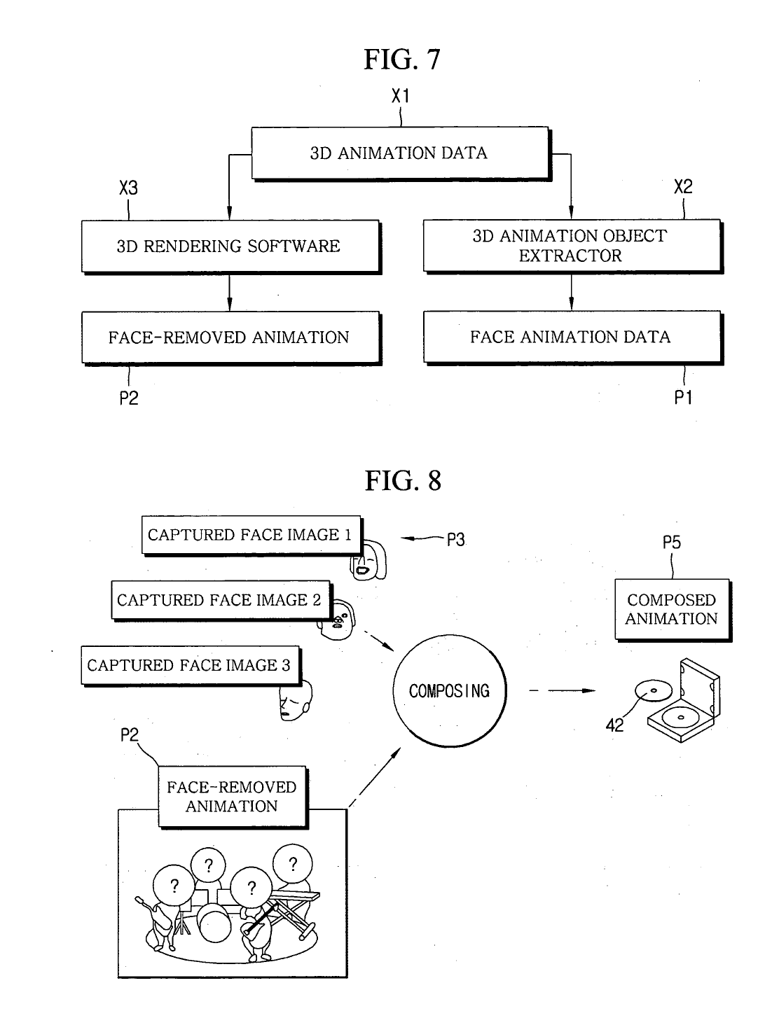

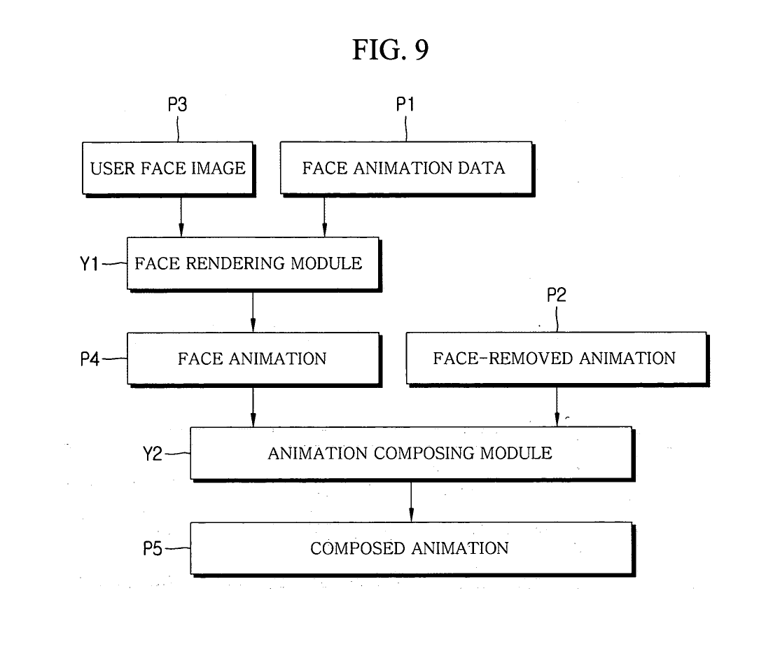

FIG. 1 is a perspective view showing an animation composing vending machine according to the present invention; FIG. 2 is a perspective view showing a rear side of the animation composing vending machine according to the present invention; FIG. 3 is a schematic view showing inner configuration of the animation composing vending machine according to the present invention; FIG. 4 is a block diagram showing the animation composing vending machine according to the present invention; FIG. 5 is a block diagram showing a modification of the animation composing vending machine according to the present invention; FIG. 6 is a flowchart illustrating an operation method of the animation composing vending machine according to the present invention; FIG. 7 is a block diagram showing the step of processing face-removed animation and face animation data previously stored in a database in the animation composing vending machine according to the present invention; and FIGS. 8 and 9 are schematic diagrams illustrating the step of composing a specific body image photographed from a user with animation contents in the animation composing vending machine according to the present invention.

As shown in the figures, the animation composing vending machine of the preset invention includes a casing 10, a monitor 20, a camera 30, a CD (Compact Disk) recorder 40, a manipulation panel 50, a controller 60 and a database (DB) unit 70.

The casing 10 has a predetermined shape to stand on a ground and gives a space for mounting every component 20, 30, 40, 50, 60, 70 mentioned above. The casing 10 may be attached to a wall or fixed by other frames, and it may also have various shapes and configurations in various ways in addition to the above.

The monitor 20 is mounted to an upper front side of the casing 10 to output various images, moving pictures and characters. Preferably, an additional monitor 22 is mounted to an upper rear side of the casing 10, which faces the monitor 20. The additional monitor 22 displays the same image as the monitor 20 so that other persons may watch the image. That is to say, the additional monitor 22 may display the information such as a look or pose taken by a user standing in front of the monitor 20 or contents selected by the user.

The camera 30 is mounted casing 10, and it is preferably positioned near to the monitor 20 so as to capture a face part of a user.

The CD recorder 40 is mounted in the casing 10 to record an animation, in which the face image of the user captured by the camera 30 is composed, in a CD 42.

The manipulation panel 50 is mounted out of the casing 10 so that a user may input a desired command using an input means such as buttons 52. The manipulation panel 50 has a plurality of buttons or a joystick, and it may also have other command input means such as a touch screen.

The controller 60 plays a role of controlling peripheral components mentioned above and composing a photographed face image of a user to make an animation, as described in detail later.

The animation composing vending machine of the present invention configured as above may further include a cash recognition unit 14. For this purpose, a cash insert hole 12 is formed in the casing 10, and the cash recognition unit 14 recognizes an amount of cash inserted into the case insert hole 12 and then notifies it to the controller 60.

In addition, the animation composing vending machine of the present invention may further include at least one lighting 80 so as to indicate light to a user when the user is photographed by the camera 30. Preferably, the lighting 80 is mounted to the casing 10 to irradiate light in the same direction as a photographing direction of the camera 30.

The animation composing vending machine of the present invention records an animation of a user in a CD and then provides the CD to the user. At this time, a cover sheet 94 for discriminating the CD 42 may be attached to the corresponding CD 42 provided to the user. For this purpose, the animation composing vending machine of the present invention may further include a cover sheet supplier 90 for supplying a cover sheet 94 for CD, and a printer 92 for printing a predetermined data on the cover sheet 94 to be supplied by the cover sheet supplier 90.

The cover sheet supplier 90 contains many empty cover sheets 94 having a suitable size and made as a sticker or the like, and it supplies a cover sheet 94 automatically when the CD 42 is provided to the user or according to a demand of the user. In addition, the printer 92 prints a predetermined data on the cover sheet 94 supplied by the cover sheet supplier 90 before the cover sheet 94 is provided to the user. At this time, the data printed on the cover sheet 94 may be a photographed image or a data directly made up by the user, and it may also contain an advertisement. The printed cover sheet 94 is discharged out through an output slit 96 formed in the casing 10.

Meanwhile, the animation composing vending machine of the present invention may further include a CD supplier 44 for supplying a CD 42 to a user. The CD supplier 44 is mounted in the casing 10 to contain a plurality of empty CDs 42, and supplies an empty CD 42 to the user according to a request of the user. After that, the user inserts the empty CD 42 into the CD recorder 40, and the CD recorder 40 records an animation of the user in the corresponding empty CD 42 and then provides it to the user.

At this time, the above CD supplying process may be automatically conducted, instead of using the above manual manner. In this case, the CD supplier 44 supplies an empty CD 42 to the CD recorder 40 directly according to a request of the user. Of course, in case a user personally possesses an empty CD, the user may insert his/her own empty CD into the CD recorder 40 without purchasing a separate CD.

In addition, though not shown in the drawings, the casing 10 may receive a plurality of CD cases so that a CD is put in a CD case when the CD supplier 44 provides the corresponding CD to a user.

In addition, the animation composing vending machine may further include a CD inspection unit (not shown) for checking normality of CD. In this case, the CD inspection unit inspects a CD in which a composed animation is recorded by the CD recorder 40, and then provides the CD to a user only when there is no defect in the CD.

Also preferably, at least one speaker 82 may be further mounted to the casing 10 so as to output a sound corresponding to various animations displayed on the monitor 20. The speaker 82 may output voice guidance or voice advertisements in addition to the sound corresponding to animations.

In addition, a cellular phone transmission module 100 may be further mounted to the casing 10 so as to transmit a composed animation to a cellular phone. The cellular phone transmission module 100 transmits a composed animation to a cellular phone using a communication cable. The composed animation transmitted to the cellular phone as mentioned above may be used later in various ways by means of DVD, PC, Internet, VCD, large projector and so on.

Here, various components mentioned above may be controlled using one controller 60 as shown in FIG. 4, and it is also possible that a separate controller controls several components such as a cash recognition unit. Preferably, the controller may include a first controller 60a for controlling components related to photographing and animation making such as the monitors 20, 22, the camera 30, the CD recorder 40, the manipulation panel 50 and various databases and processing related data, and a second controller 60b for controlling components not directly related to photographing and animation making such as the cash recognition unit 14, a card reader 16, a card settling unit 18, the CD supplier 44, the lighting 80, the speaker 82, the cover sheet supplier 90, the printer 92 and the cellular phone transmission module 100. Of course, the controller may be realized in various ways in addition to the above.

Meanwhile, a blue screen chair 84 is preferably positioned at a first position of the casing 10 where the monitor 20 is positioned. The blue screen chair 84 includes a chair 86 for giving a seating place to a user, and a blue screen 88 coupled with the chair 86 and positioned in a photographing direction of the camera. The blue screen 88 becomes a background of a user when the user is photographed, and this background may be removed when an animation is composed, and then replaced with other background animations already stored. This blue screen 88 makes it possible to photograph a user in an open status regardless of external illumination without any separate light intercepting screen.

The controller 60 instructs the monitor 20 to output a demo animation or a cash insert guidance message already stored in the DB unit 70.

In addition, if the cash recognition unit 14 confirms payment, the controller 60 instructs the monitor 20 to output a plurality of sample animations already stored in the DB unit 70 and classified based on their themes so that the user may select a desired sample animation and the number of persons participating in photographing.

In addition, if the user selects a specific sample animation and the number of persons to be photographed through the manipulation panel 50, the controller 60 instructs the camera 30 to capture an image of a face part of the user. After that the controller 60 renders the captured user face image P3 to conform to a corresponding face animation data P1 of the sample animation, stored in the DB unit 70 and selected by the manipulation panel 50, according to a predetermined program so as to make a face animation P4. After that, the controller 60 composes the face animation P4 with a face-removed animation P2 previously stored in the DB unit 70, and then the closed animation P5 is transmitted to the CD recorder 40 and recorded and stored in a CD 42.

At this time, in order to make a sample animation, facial expression and face position information of each frame should be previously recorded for each character. Data for such a frame is configured as follows.

Frame 0: character1 face_{—}0(f0_c1_{—}1,f0_y_{—}1)-(f0_{—}2,f0_c1_y2), . . .

Frame 1: character1 face_{—}1(f1_c1_{—}1,f0_c1_y1)-(f1_c1_{—}2,f0_c1_y2), . . .

Frame n: character1 face_n(fn_c1_{—}1,f0_c1_y1)-(fn_c1_{—}2,f0_c1_y2), . . .

Here, values from face_{—}0 to face_n are selected in a range of the number of predetermined facial expressions.

As shown in FIG. 7, the face animation data P1 and the face-removed animation P2 are respectively classified by data processing of a 3D animation data X1. Here, the face animation data P1 is extracted from a data-processed 3D animation data X1 by 3D animation object extractor X2, and the face-removed animation P2 is generated by executing a 3D rendering software X3.

The controller 60 as mentioned above may be a common personal computer, preferably using Window XP as a platform with specification of Intel Pentium IV CPU, RAM 512 MB or above, a graphic card of ATI Radeon 9000 or above supporting dual-monitor, but not limitedly.

The DB unit 70 includes a first DB 71 for storing a user face image P3 captured by the camera 30, a second DB 74 for storing face animation data P classified depending on theme, a third DB 76 for storing face-removed animations P2 classified depending on theme, and a fourth DB 78 for storing demo animations, various messages and sample animations classified depending on theme, which are to be displayed on the monitor 20.

Thus, as shown in FIG. 6, at ordinary times, the monitor 20 initially outputs a demo animation in which a face part of human is composed with animation contents together with a message requesting insertion of cash or card. For this reason, the controller 60 extracts the corresponding data from the fourth DB 78 and then transmits it to the monitor 20 (step S1). In addition, the number of empty CDs remaining the CD supplier 44 and the number of CD cases may also be output on the initial screen of the monitor 20.

In this state, if a user inserts cash into the cash recognition unit 14 as requested on the monitor 20 for paying a service fee, the information is transmitted to the controller 60 (step S2). After recognizing that the service fee is paid, the controller 60 transmits a plurality of sample animations, classified depending on their themes in the fourth DB 78, to the monitors 20 to be displayed thereon. The monitor 20 preferably outputs the plurality of sample animations classified depending on their themes in a chessboard shape so that the user may see them at one glance. If the pity of sample animations are output to the monitor 20 as mentioned above, the user selects a desired sample animation by manipulation of the manipulation panel 50 (step S3). After that, the user selects the number of persons to be photographed with reference to the information displayed on the monitor 20 (step S4).

Then, the controller 60 operates the camera 30 to capture a face image of the user standing in front of the blue screen 88. When the camera 30 photographs the face of the user, the user may make a facial expression according to the selected sample animation displayed on the monitor 20. The camera 30 captures there to four images for one user in various poses. When the camera 30 captures an image, the lighting 80 may irradiate light. The lighting 80 indicates light to the user under the control of the controller 60. After that, a blue screen region is removed from the photographed user image using a common chroma-key technique, and a region below the neck is also removed using a face mask already prepared so as to generate a face image of the user. The user face image P3 generated as mentioned above is stored in the first DB 72 (step S5).

If the user is photographed as mentioned above, the controller 60 renders the captured user face image P3 to conform to a corresponding face animation data P1 of the sample animation selected by the manipulation panel 50 and previously stored in the second DB 74 according to a predetermined program, thereby making a face animation P4. In addition, the controller 60 then composes the face animation P4 with a face-removed animation P2 previously stored in the third DB 76 that plays a role of a background animation, thereby making a composed animation P5 (step S6). At this time, a composing position of the user face image P3 is determined depending on a box-shaped face portion of the face-removed animation P2.

That is to say, as shown in FIGS. 8 and 9, the compeller 60 executes a face rendering module Y1 according to a predetermined program so that a captured user face image P3 is rendered conforming to a corresponding face animation data P1 of the sample animation selected by the manipulation panel 50 to make the face animation P4, and then executes an animation composing module Y2 to compose the face animation P4 with a corresponding face-removed animation P2 of the sample animation selected by the manipulation panel 50, thereby making a composed animation P5.

The above composed animation P5 is recorded and stored in an empty CD 42, which is inserted into the CD recorder 40 (step S7). At this time the CD 42 inserted into the CD recorder 40 may have been possessed by the user or supplied from the CD supplier 44 on the control of the controller 60 in the step S2. In addition, the empty CD 42 may be provided to the user from the CD supplier 44 and then manually inserted into the CD recorder 40, or it may be automatically supplied to the CD 40 directly from the CD supplier 44. The composed animation P5 recorded and stored in the CD 42 is a MPEG moving picture that may be output for 3 to 4 minutes, according to MPEG1 standards with a picture size of 352×240, 30 frames per second (29.97 fps), 10 MB per one minute, 30˜40 MB per one song, for example. While the composed animation P5 is being recorded and stored in the CD 42, the printer 92 prints a predetermined data such as a composed picture on a cover sheet 94 to be attached on the case of the CD 42, and then outputs the cover sheet 94 out of the casing 10 (step S8). In addition, the composed animation P5 recorded and stored in the CD 42 is partially output through the monitor 20, and at this time a sound corresponding to the composed animation may be output together through the speaker 82.

If the composed animation P5 is completely recorded and stored in the CD 42, the CD 42 is discharged out together with a CD case for the user to carry, and the controller 60 displays a message on the monitor 20 to inquire whether an additional copy is required. If the user wants an additional one, the above procedure is repeated, while, if the user does not want an additional copy, the monitor 20 outputs an initial screen (step S9).

Meanwhile, if the user desires to downward the composed animation P5 to a cellular phone in the above procedure, the user may download the composed animation P5 by connecting his/her own cellular phone to a communication cable of the cellular phone transmission module 100, and then manipulating the manipulation panel 50.

As described above, the present invention has been described in detail referring to the accompanying drawing. However, it should be understood that the detailed description and specific embodiments of the invention are given by way of illustration only, not intended to limit the scope of the invention, since various changes and modifications within the spirit and scope of the invention will become apparent to those skilled in the art from this detailed description, so it should be that other equivalents and modifications within the spirit and scope of the invention will become apparent to those skilled in the art from this detailed description.

### APPLICABILITY TO THE INDUSTRY

As described above, the present invention allows automatic composition of animation contents and a body part image photographed from a user, so there is no need of operator and a labor cost is reduced. In addition, expensive 3D rendering software and high-performance computer may not be used. Moreover, the present invention may be easily realized as a vending machine positioned outdoors.

1. An animation composing vending machine, comprising:
a casing;
a monitor mounted to the casing;
a camera mounted to the casing to photograph a user;
a CD (Compact Disk) recorder mounted to the casing to record on a CD a composed animation of a user body part image photographed by the camera;
a manipulation panel mounted to the casing so as to receive the user desired command;
a controller operatively connected to the monitor, the camera, the CD recorder and the manipulation panel, wherein said controller processes the user body part image photographed by the camera into a composed animation and transmits the composed animation to the CD recorder; and
a database unit operatively connected to the controller to store the user body part image photographed by the camera and the composed animation.

2. The animation composing vending machine according to claim 1, wherein the user body part image is a user face image, wherein the database unit stores face animation data classified depending on themes, demo animations output to the monitor and sample animations classified according to themes, wherein the controller instructs the monitor to output the already stored demo animation and a message for guiding payment, instructs the monitor to output a plurality of already stored sample animations so that the user selects a desired sample animation and the number of persons to be photographed, instructs the camera to capture a user face image when a specific sample animation and the number of persons to be photographed are selected through the manipulation panel, renders the captured user face image conforming to a corresponding face animation data of the selected sample animation according to a predetermined program to generate a face animation, composes the generated face animation with a face-removed animation of the corresponding sample animation, and transmits the composed animation to the CD recorder so that the composed animation is stored in the CD.

3. The animation composing vending machine according to claim 2, wherein the face animation data and the face-removed animation are data respectively obtained by data processing of 3D animation.

4. The animation composing vending machine according to claim 1, wherein a cellular phone transmission module is mounted to the casing so as to transmit the composed animation made by the controller to a cellular phone.

5. The animation composing vending machine according to claim 1, wherein a cash insert hole is formed in the casing, and wherein the animation composing vending machine further comprises a cash recognition unit for recognizing insertion of cash through the cash insert hole.

6. The animation composing vending machine according to claim 1, further comprising at least one lighting mounted to the casing to irradiate light to the user when the user is photographed by the camera.

7. The animation composing vending machine according to claim 1, further comprising:
a cover sheet supplier mounted in the casing to supply a cover sheet to be attached to the CD in which the composed animation is recorded; and
a printer for printing a predetermined data on the cover sheet supplied by the cover sheet supplier.

8. The animation composing vending machine according to claim 1, further comprising a blue screen chair, which comprises a chair positioned in front of the casing, and a blue screen coupled to the chair and provided in a photographing direction of the camera.

9. The animation composing vending machine according to claim 8, wherein the user body part image is a user face image, wherein the camera photographs the user with the blue screen as a background, and wherein the controller removes a blue screen region from the photographed user face image using a chroma-key technique, and removes a region below the neck from the photographed user face image by means of a previously prepared face mask so as to generate a processed user face image.

10. The animation composing vending machine according to claim 1, further comprising a CD supplier mounted to the casing to contain at least one CD, the CD supplier supplying a CD to the user according to a request of the user.

11. The animation composing vending machine according to claim 1, further comprising a CD supplier mounted to the casing to contain at least one CD, the CD supplier automatically supplying a CD to the CD recorder according to a request of the user.

12. The animation composing vending machine according to claim 11, further comprising a CD inspection unit for checking normality of the CD in which the composed animation is recorded by the CD recorder so that only a CD with no defect is provided to the user.

13. The animation composing vending machine according to claim 1, wherein the CD in which the composed animation is recorded by the CD recorder is provided to the user together with a CD case.

14. The animation composing vending machine according to claim 1, further comprising an additional monitor mounted to the casing to display the same image as the monitor.

15. The animation composing vending machine according to claim 1, further comprising at least one speaker mounted to the casing to output a sound corresponding to an animation displayed on the monitor.

16. The animation composing vending machine according to claim 1, wherein the user body part image is a user face image.

17. The animation composing vending machine according to claim 16, wherein the database unit stores face animation data classified depending on themes, demo animations output to the monitor, and sample animations classified according to themes.
